(19) United States
(12) Patent Application Publication
(10) Pub. No.: US 2014/0292671 A1
(43) Pub. Date: Oct. 2, 2014

(54) DATA SHARING SYSTEM AND DATA SHARING METHOD THEREOF

(71) Applicant: Acer Incorporated, New Taipei City (TW)

(72) Inventors: Meng-Shih Tsai, New Taipei City (TW); Chueh-Pin Ko, New Taipei City (TW)

(21) Appl. No.: 13/935,566

(22) Filed: Jul. 5, 2013

(30) Foreign Application Priority Data
Mar. 29, 2013 (TW) 102111456

(51) Int. Cl. G06F 3/041

(52) U.S. Cl. CPC G06F 3/041
USPC 345/173

(57) ABSTRACT

A data sharing system and a data sharing method thereof are provided. In the data sharing method, a file information corresponding to first coordinate patterns of a first electronic device detected by a input device and a device information of the first electronic device are stored, and when second coordinate patterns of a second electronic device are detected by the input device, the file information is transmitted to the second electronic device according to a data transmission instruction.

### CROSS-REFERENCE TO RELATED APPLICATION

This application claims the priority benefit of Taiwan application serial no. 102111456, filed on Mar. 29, 2013. The entirety of the above-mentioned patent application is hereby incorporated by reference herein and made a part of this specification.

### BACKGROUND OF THE INVENTION

1. Field of the Invention

The present invention generally relates to a data sharing method, and more particularly, to a data sharing system and a data sharing method thereof.

2. Description of Related Art

Conventionally, a display panel is used for displaying information and output signals from the system, while other input devices are used for inputting signals to the system. A touch panel is a display panel which can receive user inputs through the user's touch actions. Namely, a touch panel offers both input and output functions and allows the user to interact with the display panel or the system coupled to the display panel. For example, touch panels can be applied to cell phones, notebook computers, and tablet computers in order to bring a diversified input experience to the users.

Touch panels (or touch screens) have many different designs, such as resistive touch panels, surface-wave touch panels, capacitive touch panels, and infrared touch panels. Regardless of the type of a touch panel, its purpose is to offer a convenient input experience to the user. For example, resistive touch panels, surface-wave touch panels, capacitive touch panels, and infrared touch panels can all be operated by using a finger or a stylus. However, existing touch panels still need to be improved even though they can offer the users very intuitional operation experiences.

### SUMMARY OF THE INVENTION

Accordingly, the present invention is directed to a data sharing system and a data sharing method thereof, in which a simplified data sharing mechanism between different electronic devices is provided.

The present invention provides a data sharing method suitable for sharing data between a first electronic device having a first display unit and a second electronic device having a second display unit through an input device. The first display unit has a plurality of first coordinate patterns, and the second display unit has a plurality of second coordinate patterns. The data sharing method includes following steps. The first coordinate patterns are detected by using the input device, wherein each of the first coordinate patterns has a first primary graphic feature, and the first primary graphic feature indicates a device information of the first electronic device. Whether a capturing instruction is received is determined. If the capturing instruction is received, a file information corresponding to the first coordinate patterns detected by the input device is stored. The second coordinate patterns are detected by using the input device, wherein each of the second coordinate patterns has a second primary graphic feature, and the second primary graphic feature indicates a device information of the second electronic device. Whether a data transmission instruction is received is determined. If the data transmission instruction is received, the file information is transmitted to the second electronic device.

According to an embodiment of the present invention, the data sharing method further includes following steps. The device information of the first electronic device corresponding to the first coordinate patterns and the device information of the second electronic device corresponding to the second coordinate patterns are stored.

According to an embodiment of the present invention, the step of transmitting the file information to the second electronic device further includes following steps. A transmission control signal is output to the first electronic device according to the file information, the device information of the first electronic device, and the device information of the second electronic device to control the first electronic device to transmit a file content corresponding to the file information to the second electronic device.

The present invention provides a data sharing system including a first electronic device, a second electronic device, and an input device. The first electronic device has a first display unit, and the first display unit has a plurality of first coordinate patterns, wherein each of the first coordinate patterns has a first primary graphic feature, and the first primary graphic feature indicates a device information of the first electronic device. The second electronic device has a second display unit, and the second display unit has a plurality of second coordinate patterns, wherein each of the second coordinate patterns has a second primary graphic feature, and the second primary graphic feature indicates a device information of the second electronic device. The input device detects the first coordinate patterns and the second coordinate patterns, stores a file information corresponding to the first coordinate patterns detected by the input device according to a capturing instruction, and when the second coordinate patterns are detected, transmits the file information to the second electronic device according to a data transmission instruction.

According to an embodiment of the present invention, each of the first coordinate patterns further includes a first secondary graphic feature, and the first secondary graphic feature indicates a coordinate position on the first display unit. Each of the second coordinate patterns further includes a second secondary graphic feature, and the second secondary graphic feature indicates a coordinate position on the second display unit.

According to an embodiment of the present invention, the first secondary graphic features and the second secondary graphic features include at least one of inclination angles and dimensions of the first coordinate patterns and the second coordinate patterns, each of the first coordinate patterns and each of the second coordinate patterns respectively include a first graph and a second graph. The first secondary graphic feature and the second secondary graphic feature respectively include at least one of a position, an inclination angle, a number, a shape of the second graph, a border shape of the first graph and a shape of a hole in the first graph.

According to an embodiment of the present invention, the file information includes a file content corresponding to the first coordinate patterns in the first electronic device.

According to an embodiment of the present invention, the input device includes a detection unit, a storage unit, a processing unit, and a wireless transmission unit. The detection unit detects the first coordinate patterns and the second coordinate patterns. The storage unit stores a file information and the device information of the first electronic device corresponding to the first coordinate patterns detected by the detection unit and the device information of the second electronic device corresponding to the second coordinate patterns detected by the detection unit. The processing unit is coupled to the detection unit and the storage unit. The processing unit controls the storage unit to store the file information corresponding to the first coordinate patterns detected by the detection unit according to a capturing instruction, and when the second coordinate patterns are detected, the processing unit transmits the file information to the second electronic device according to a data transmission instruction. The wireless transmission unit is coupled to the processing unit. The wireless transmission unit transmits data between the first electronic device and the second electronic device in a wireless manner.

According to an embodiment of the present invention, the file information indicates a file name or path corresponding to the first coordinate patterns in the first electronic device. The processing unit further outputs a transmission control signal to the first electronic device according to the file information, the device information of the first electronic device, and the device information of the second electronic device to control the first electronic device to transmit a file content corresponding to the file information to the second electronic device.

According to an embodiment of the present invention, the file information includes the file content corresponding to the first coordinate patterns in the first electronic device.

As described above, in the present invention, a file information corresponding to first coordinate patterns detected by an input device and device information of the first electronic device are stored through the input device, and when second coordinate patterns are detected, the file information is transmitted to a second electronic device according to a data transmission instruction, so as to share data between the first electronic device and the second electronic device. Thereby, in the present invention, the user's operation to share data between different electronic devices is greatly simplified and accordingly a user can conveniently share data between these electronic devices.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a data sharing system according to an embodiment of the present invention.

FIG. 2 is a diagram illustrating the distribution of coordinate patterns on a display unit according to an embodiment of the present invention.

FIGS. 3A-3H are diagrams illustrating secondary graphic features of coordinate patterns according to embodiments of the present invention.

FIG. 4 is a diagram of an input device according to an embodiment of the present invention.

FIG. 5 is a flowchart of a data sharing method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

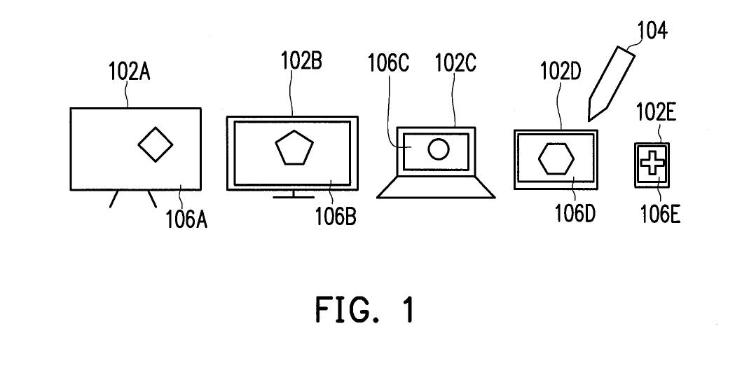

FIG. 1 is a diagram of a data sharing system according to an embodiment of the present invention. Referring to FIG. 1, the data sharing system includes a plurality of electronic devices 102A-102E and an input device 104. As shown in FIG. 1, the electronic devices 102A-102E are respectively an electronic white board, a television, a notebook computer, a tablet computer, and a cell phone. However, the present invention is not limited thereto. The input device 104 may be a stylus, a touch ring, a mouse, a remote control, a track ball, a cell phone, or a tablet computer. In the present embodiment, the input device 104 is a stylus. The electronic devices 102A-102E respectively have display units 106A-106E. Each of the display units 106A-106E may be a display panel or touch display panel and has a plurality of coordinate patterns (for the convenience of description, in FIG. 1, only one coordinate pattern is illustrated on each display unit as an example). The coordinate patterns are formed on the surfaces of the display units or inside the display units through a process. The coordinate patterns of different electronic devices have different primary graphic features. The primary graphic features indicate device information (for example, names, serial numbers, and connection passwords, etc) of the corresponding electronic devices. For example, the primary graphic features of the coordinate patterns on the electronic devices 102A-102E are respectively in a diamond shape, a pentagonal shape, a circular shape, a hexagonal shape, and a cross shape. It should be noted that in other embodiments, the shapes of the coordinate patterns are not limited to foregoing examples and may be any other geometric shape.

The input device 104 detects the coordinate patterns on the electronic devices 102A-102E and transmits data among different electronic devices accordingly. Taking the data transmission between the electronic device 102D and the electronic device 102E as an example, when the input device 104 detects the coordinate patterns on the electronic device 102D, the input device 104 stores a file information corresponding to the coordinate patterns according to a capturing instruction, and when the input device 104 detects the coordinate patterns on the electronic device 102E, the input device 104 transmits the file information to the electronic device 102E according to a data transmission instruction, so as to share the data between the two electronic devices. Herein the file information corresponding to the coordinate patterns may be the content of file icons appearing at positions indicated by the coordinate patterns. The file information may be transmitted through following techniques. The actual file content of the electronic device 102D is stored in the input device 104 (i.e., the file information contains the actual file content) and transmitted by the input device 104 to the electronic device 102E. Or, the input device 104 only stores the file name or path of the electronic device 102D and the device information (for example, information names, connection information, and serial numbers, etc) of the electronic devices 102D and 102E. When the input device 104 receives a data transmission instruction, the input device 104 issues a transmission control signal to notify the electronic device 102D, so as to allow the electronic device 102D to transmit the file content to the electronic device 102E. Thus, the problem of impossible file sharing due to insufficient storage space in the input device 104 can be avoided, and besides, by transmitting the file content through the electronic device 102D, the transmission speed won't be restricted.

Aforementioned capturing instruction and data transmission instruction can be issued by pressing physical buttons disposed on the input device 104. For example, a user presses a physical button on the input device 104 to issue the capturing instruction when the input device 104 detects the coordinate patterns on the electronic device 102D, and the user keeps pressing the physical button until the input device 104 detects the coordinate patterns on the electronic device 102E in order to issue the data transmission instruction. Additionally, if the user decides not to share the data after capturing the file information, the user can press down the physical button when the input device 104 does not detect any coordinate pattern on the electronic device 102E to issue a give-up instruction, so as to allow the input device 104 to give up the transmission of the file information. In some embodiments, another physical button may be disposed for issuing the give-up instruction.

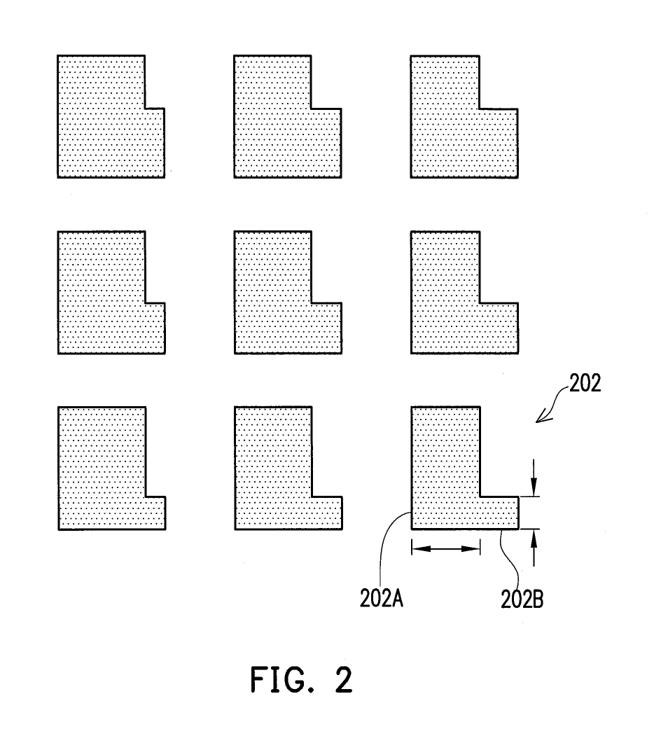

To be specific, the coordinate patterns on the electronic devices 102A-102E are nearly unnoticeable to human eyes and are distributed on the display units 106A-106E without affecting the display quality of the display units 106A-106E. Besides the primary graphic feature indicating the device information of the electronic device, each coordinate pattern further includes a secondary graphic feature indicating a coordinate position on the display unit. FIG. 2 is a diagram illustrating the distribution of coordinate patterns on a display unit according to an embodiment of the present invention. As shown in FIG. 2, the primary graphic feature of each coordinate pattern 202 has an “L” shape, and each coordinate pattern 202 is composed of a graph 202A and a graph 202B. In the present embodiment, the secondary graphic feature of each coordinate pattern 202 is determined by the bottom width of the graph 202A and the height of the graph 202B. Because coordinate patterns 202 at different coordinate positions have different bottom widths of the graphs 202A and/or different heights of the graphs 202B (i.e., the coordinate patterns 202 at different coordinate positions have different secondary graphic features), the secondary graphic feature of each coordinate pattern 202 can be used for indicating a coordinate position on the display unit.

As described above, because the secondary graphic feature of each coordinate pattern indicates a coordinate position on the display unit, when data is shared between different electronic devices through the input device, the file content corresponding to any coordinate pattern (coordinate position) on an electronic device can be further transmitted to a coordinate position appointed by a user (i.e., the position of a coordinate pattern detected by the user by using the input device) on another electronic device (for example, to an application program represented by the coordinate position indicated by the coordinate pattern on the other electronic device so that the user can share file data in a more intuitional way). For example, an image file on an electronic device can be directly transmitted to an image browsing program on another electronic device to be viewed or edited. Or, a music file on an electronic device can be transmitted to a music playing program on another electronic device to be played in real time. Or, a file on an electronic device can be transmitted to an email program on another electronic device to be attached to a new email. Variations and combinations of foregoing applications can be created according to the user's requirement to offer more diversified functions.

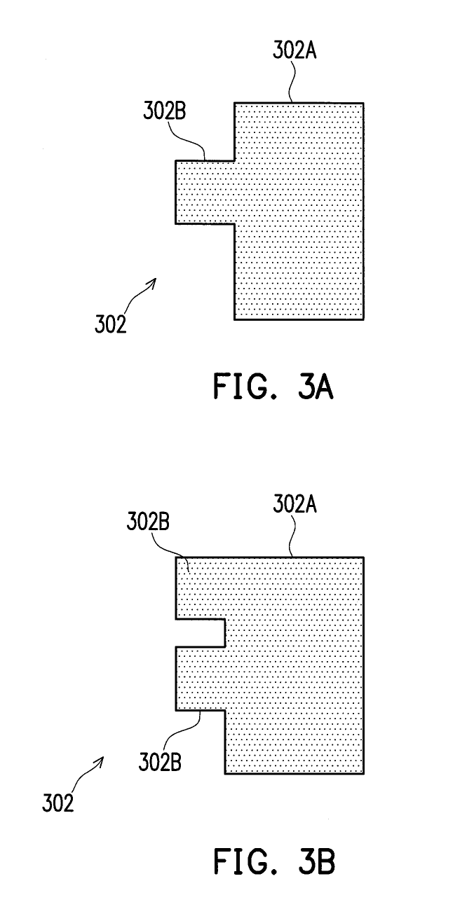

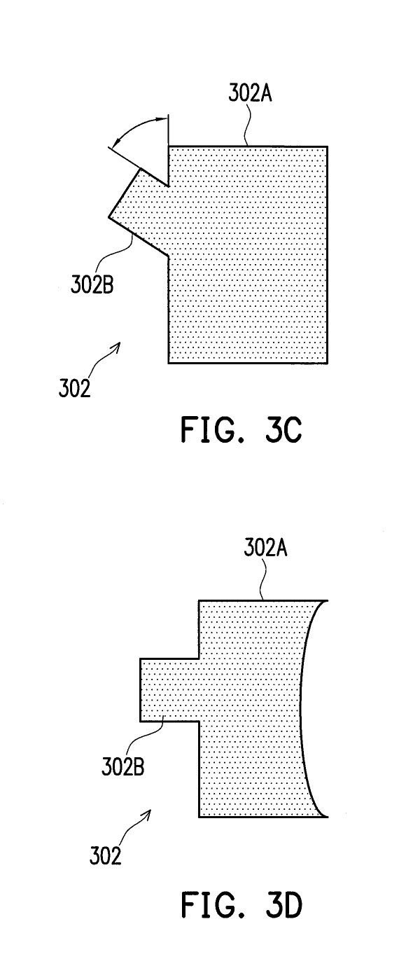

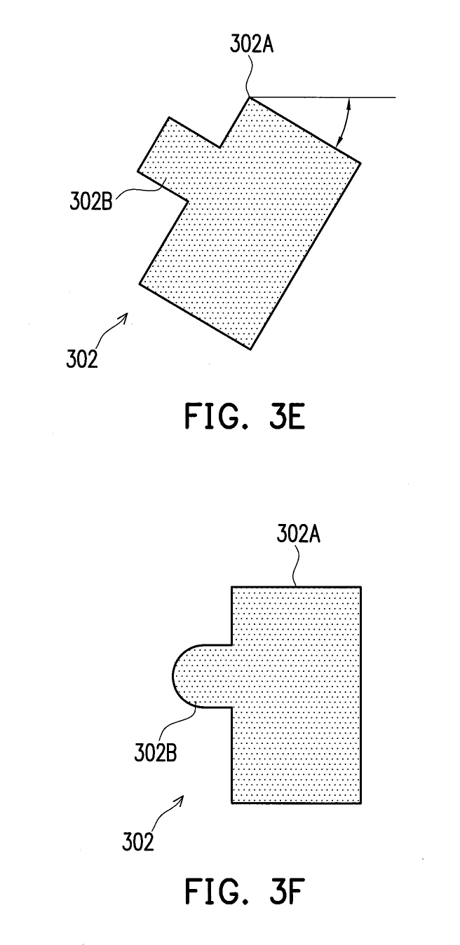

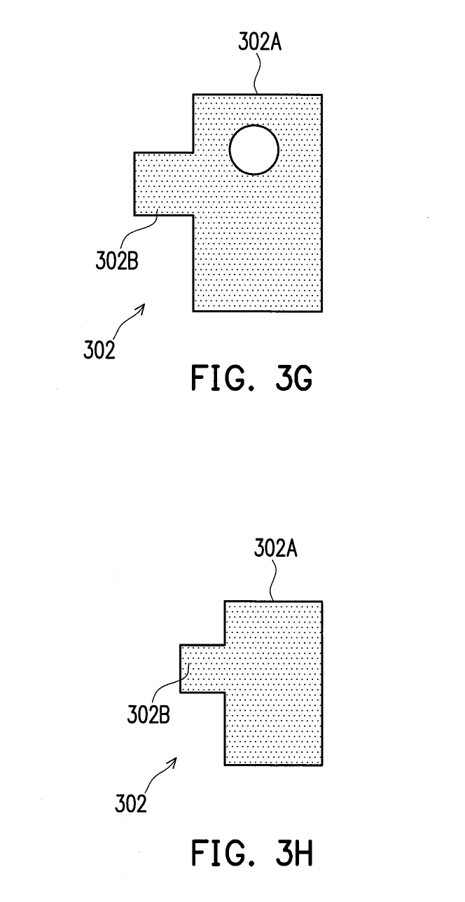

It should be noted that the secondary graphic feature of the coordinate pattern 202 in the embodiment illustrated in FIG. 2 is only an example, and in other embodiments, the secondary graphic feature of the coordinate pattern 202 may also be determined through different techniques. FIGS. 3A-3H are diagrams illustrating secondary graphic features of coordinate patterns according to embodiments of the present invention. Referring to FIGS. 3A-3H, in FIG. 3A, the secondary graphic feature of the coordinate pattern 302 is determined by the position of the graph 302B on the graph 302A. In FIG. 3B, the secondary graphic feature of the coordinate pattern 302 is determined by the number of the graphs 302B. In FIG. 3C, the secondary graphic feature of the coordinate pattern 302 is determined by the inclination angle of the graph 302B. In FIG. 3D, the secondary graphic feature of the coordinate pattern 302 is determined by the border shape (curvature) of the graph 302A. In FIG. 3E, the secondary graphic feature of the coordinate pattern 302 is determined by the inclination angle of the coordinate pattern 302. In FIG. 3F, the secondary graphic feature of the coordinate pattern 302 is determined by the shape of the graph 302B. In FIG. 3G, the secondary graphic feature of the coordinate pattern 302 is determined by the shape of the hole in the graph 302A. In FIG. 3H, the secondary graphic feature of the coordinate pattern 302 is determined by the size of the coordinate pattern 302.

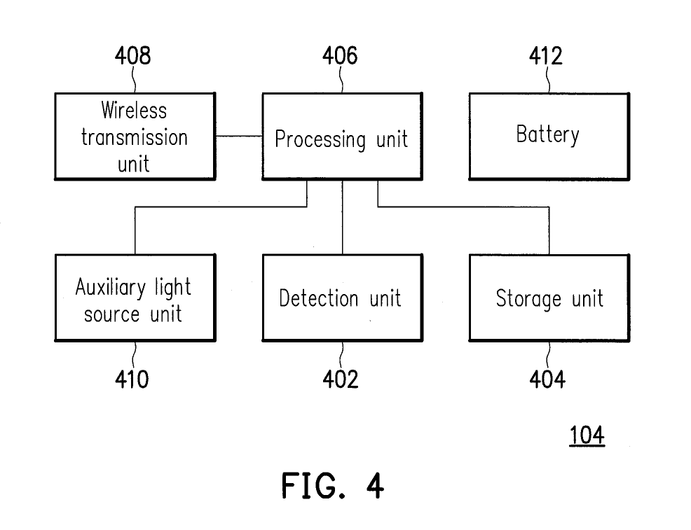

FIG. 4 is a diagram of an input device according to an embodiment of the present invention. Referring to FIG. 4, to be specific, in the present embodiment, the input device 104 in FIG. 1 includes a detection unit 402, a storage unit 404, a processing unit 406, a wireless transmission unit 408, an auxiliary light source unit 410, and a battery 412. The processing unit 406 is coupled to the detection unit 402, the storage unit 404, the wireless transmission unit 408, the auxiliary light source unit 410, and the battery 412. The battery 412 is coupled to the detection unit 402, the storage unit 404, the wireless transmission unit 408, and the auxiliary light source unit 410. To simplify the drawing, the couplings among foregoing components are not illustrated. The detection unit 402 detects the coordinate patterns on the electronic devices 102A-102E. The storage unit 404 stores file information corresponding to the coordinate patterns detected by the detection unit 402 and corresponding device information of the electronic devices. The processing unit 406 controls the storage unit 404 to store the file information corresponding to the coordinate patterns detected by the detection unit 402 according to a capturing instruction, and when the coordinate patterns of another electronic device are detected, transmits file information of the previously detected electronic device to the subsequently detected electronic device according to a data transmission instruction. The wireless transmission unit 408 transmits data between different electronic devices in a wireless manner under the control of the processing unit 406.

Aforementioned file information indicates the name or path of a file corresponding to the coordinate patterns in the electronic device 102D, and which may include the actual file content corresponding to the coordinate patterns or only the name or path of the file corresponding to the coordinate patterns. If the file information includes the actual file content, once the processing unit 406 receives a data transmission instruction, the processing unit 406 directly transmits the file information (including the actual file content) of the electronic device 102D to the positions corresponding to the coordinate patterns detected by the detection unit 402 in another electronic device 102E through the wireless transmission unit 408.

If the file information includes only the file name or path of the electronic device 102D, once the processing unit 406 receives a data transmission instruction, the processing unit 406 issues a transmission control signal to the electronic device 102D through the wireless transmission unit 408 according to the file information and the device information of the electronic device 102D, so as to control the electronic device 102D to transmit the file content to the positions corresponding to the coordinate patterns detected by the detection unit 402 in another electronic device 102E, so that the problem of impossible file sharing caused by insufficient storage space in the storage unit 404 can be avoided.

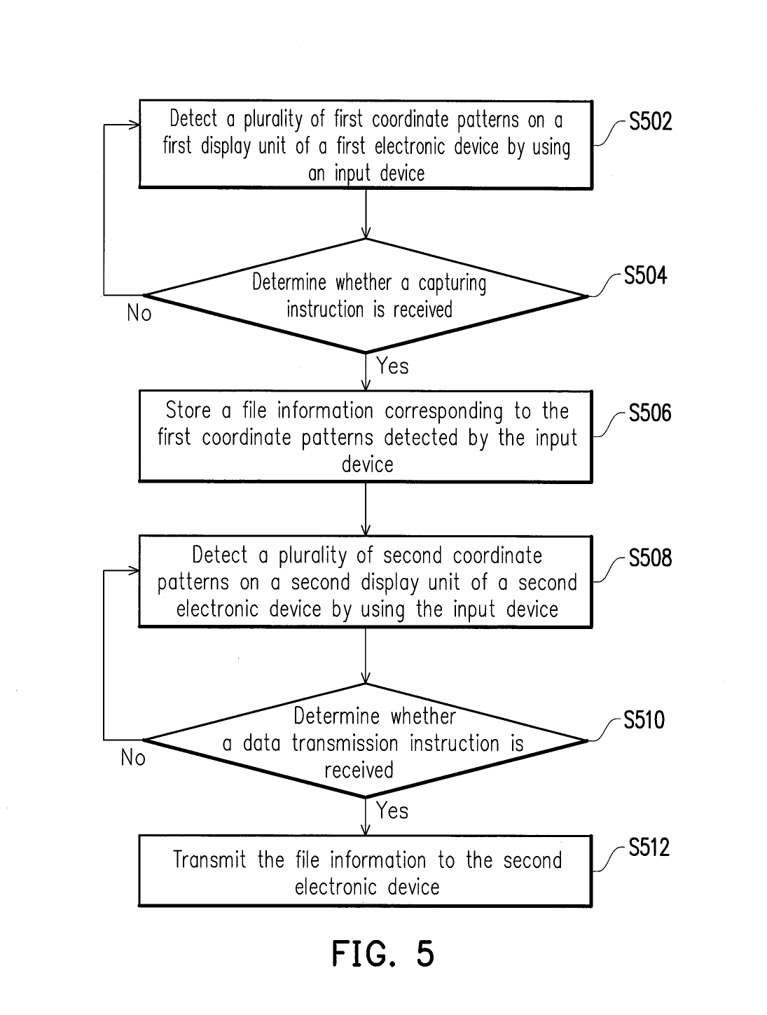

FIG. 5 is a flowchart of a data sharing method according to an embodiment of the present invention. Referring to FIG. 5, the data sharing method of the data sharing system described above includes following steps. First, a plurality of first coordinate patterns on a first display unit of a first electronic device are detected by using an input device (step S502), wherein each of the first coordinate patterns has a first primary graphic feature and a first secondary graphic feature. The first primary graphic feature indicates a device information of the first electronic device, and the first secondary graphic feature indicates a coordinate position on the first display unit of the first electronic device. Then, whether a capturing instruction is received is determined (step S504). If the capturing instruction is not received, the input device continuously detects the first coordinate patterns are detected again. If the capturing instruction is received, a file information corresponding to the first coordinate patterns detected by the input device is stored (step S506). Next, a plurality of second coordinate patterns on a second display unit of a second electronic device are detected by using the input device (step S508), wherein each second coordinate pattern has a second primary graphic feature and a second secondary graphic feature The second primary graphic feature indicates a device information of the second electronic device, and the second secondary graphic feature indicates a coordinate position on the second display unit of the second electronic device. Variations of the first primary graphic features and the first secondary graphic features of the first coordinate patterns and the second primary graphic features and the second secondary graphic features of the second coordinate patterns have been described in foregoing embodiments therefore will not be described herein.

Thereafter, whether a data transmission instruction is received is determined (step S510). If the data transmission instruction is not received, the input device continuously detects the second coordinate patterns. Contrarily, if the data transmission instruction is received, the file information is transmitted to the second electronic device (step S512). The file information may include only the file name or path corresponding to the first coordinate patterns or may further include the actual file content. If the file information includes the actual file content, the file information can be transmitted to positions corresponding to the second coordinate patterns in the second electronic device through the input device. If the file information includes only the file name or path, a transmission control signal is output to the first electronic device according to the file information, the device information of the first electronic device, and the device information of the second electronic device, so as to control the first electronic device to transmit the file content corresponding to the file information to the positions corresponding to the second coordinate patterns detected by the input device in the second electronic device, so that the problem of impossible file sharing caused by insufficient storage space in the input device can be avoided.

In addition, during the procedure of the data sharing method described above, whether a give-up instruction is received can be determined at any time. If the give-up instruction is not received, steps of the data sharing method are further executed. If the give-up instruction is received, the transmission of file information is discarded.

As described above, in the present invention, a file information corresponding to coordinate patterns detected by an input device is stored through the input device, and when coordinate patterns of another electronic device are detected, the file information is transmitted to the other electronic device according to a data transmission instruction, so that data is shared between the two electronic devices. Thereby, in the present invention, the user's operation to share data between different electronic devices is greatly simplified and accordingly a user can conveniently share data between these electronic devices. The file information can be transmitted by the input device or by an electronic device under the control of the input device, so that the problem of impossible file sharing caused by insufficient storage space in the input device can be avoided, and by transmitting the file content through the electronic device, the transmission speed is not restricted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data sharing method, suitable for sharing data between a first electronic device having a first display unit and a second electronic device having a second display unit through an input device, wherein the first display unit has a plurality of first coordinate patterns, and the second display unit has a plurality of second coordinate patterns, the data sharing method comprising:
detecting the first coordinate patterns by using the input device, wherein each of the first coordinate patterns has a first primary graphic feature, and the first primary graphic feature indicates a device information of the first electronic device;
determining whether a capturing instruction is received;
when the capturing instruction is received, storing a file information corresponding to the first coordinate patterns detected by the input device;
detecting the second coordinate patterns by using the input device, wherein each of the second coordinate patterns has a second primary graphic feature, and the second primary graphic feature indicates a device information of the second electronic device;
determining whether a data transmission instruction is received; and
when the data transmission instruction is received, transmitting the file information to the second electronic device.

2. The data sharing method according to claim 1, wherein each of the first coordinate patterns further comprises a first secondary graphic feature, the first secondary graphic feature indicates a coordinate position on the first display unit, each of the second coordinate patterns further comprises a second secondary graphic feature, and the second secondary graphic feature indicates a coordinate position on the second display unit.

3. The data sharing method according to claim 1 further comprising:
storing the device information of the first electronic device corresponding to the first coordinate patterns and the device information of the second electronic device corresponding to the second coordinate patterns.

4. The data sharing method according to claim 3, wherein the step of transmitting the file information to the second electronic device comprises:
outputting a transmission control signal to the first electronic device according to the file information, the device information of the first electronic device, and the device information of the second electronic device to control the first electronic device to transmit a file content corresponding to the file information to the second electronic device.

5. The data sharing method according to claim 1, wherein the file information comprises a file content corresponding to the first coordinate patterns in the first electronic device.

6. A data sharing system, comprising:
a first electronic device, having a first display unit, wherein the first display unit has a plurality of first coordinate patterns, each of the first coordinate patterns has a first primary graphic feature, and the first primary graphic feature indicates a device information of the first electronic device;
a second electronic device, having a second display unit, wherein the second display unit has a plurality of second coordinate patterns, each of the second coordinate patterns has a second primary graphic feature, and the second primary graphic feature indicates a device information of the second electronic device; and
an input device, detecting the first coordinate patterns and the second coordinate patterns, storing a file information corresponding to the first coordinate patterns detected by the input device according to a capturing instruction, and when the second coordinate patterns are detected, transmitting the file information to the second electronic device according to a data transmission instruction.

7. The data sharing system according to claim 6, wherein each of the first coordinate patterns further comprises a first secondary graphic feature, the first secondary graphic feature indicates a coordinate position on the first display unit, each of the second coordinate patterns further comprises a second secondary graphic feature, and the second secondary graphic feature indicates a coordinate position on the second display unit.

8. The data sharing system according to claim 7, wherein the first secondary graphic features and the second secondary graphic features comprise at least one of inclination angles and dimensions of the first coordinate patterns and the second coordinate patterns, each of the first coordinate patterns and each of the second coordinate patterns respectively comprise a first graph and a second graph, and the first secondary graphic feature and the second secondary graphic feature respectively comprise at least one of a position, an inclination angle, a number, a shape of the second graph, a border shape of the first graph and a shape of a hole in the first graph.

9. The data sharing system according to claim 6, wherein the file information comprises a file content corresponding to the first coordinate patterns in the first electronic device.

10. The data sharing system according to claim 6, wherein the input device comprises:
a detection unit, detecting the first coordinate patterns and the second coordinate patterns;
a storage unit, storing a file information and the device information of the first electronic device corresponding to the first coordinate patterns detected by the detection unit and the device information of the second electronic device corresponding to the second coordinate patterns detected by the detection unit;
a processing unit, coupled to the detection unit and the storage unit, controlling the storage unit to store the file information corresponding to the first coordinate patterns detected by the detection unit according to a capturing instruction, and when the second coordinate patterns are detected, transmitting the file information to the second electronic device according to a data transmission instruction; and
a wireless transmission unit, coupled to the processing unit, and transmitting data between the first electronic device and the second electronic device in a wireless manner.

11. The data sharing system according to claim 10, wherein the file information indicates a file name or path corresponding to the first coordinate patterns in the first electronic device, the processing unit further outputs a transmission control signal to the first electronic device according to the file information, the device information of the first electronic device, and the device information of the second electronic device to control the first electronic device to transmit a file content corresponding to the file information to the second electronic device.

12. The data sharing system according to claim 10, wherein the file information comprises a file content corresponding to the first coordinate patterns in the first electronic device.
